(19) United States
(12) Patent Application Publication
(10) Pub. No.: US 2013/0186802 A1
(43) Pub. Date: Jul. 25, 2013

(54) ThermoTube: A Portable and Human-Powered Food Containment and Temperature Conditioning System

(71) Applicant: Yul Williams, Upper Marlboro, MD (US)

(72) Inventor: Yul Williams, Upper Marlboro, MD (US)

(21) Appl. No.: 13/355,542

(22) Filed: Jan. 22, 2012

(51) Int. Cl. H05B 1/00; B65D 25/02

(52) U.S. Cl. 206/573

(57) ABSTRACT

A portable container wherein and food may be heated by a built-in and manually powered heating system without removal of the food from the container. Unlike typical containers, the device incorporates reheats the contents using human-powered energy. The device is composed of a sealable food containment chamber, a power generator, a heating element and electronics to minimize overheating of the contents. Many portable insulated food containers on the market are capable of storing food for short time periods within a specific range of temperatures. The goal is to preserve the temperature as close to the original containment temperature as possible. If food is contained longer than the rated time, or the container is opened and closed frequently, the food temperature degrades rapidly. The device addresses this problem because the food may be reheated within the existing chamber without removing it.

This invention relates to compact and portable containment units for carrying beverages and food; to food and beverage warmers; and is particularly concerned with compact heating devices that may be used in camping and personal survival applications. In accordance with 35 U.S.C. §119(e), this application corresponds directly to U.S. provisional application No. 61/426,916 which was filed on Dec. 23, 2010 with the identical title of the present invention.

### BRIEF DESCRIPTION OF THE INVENTION

1. Field of the Invention

There exists a great need for portable food and beverage containers that possess the ability to reheat the contents of said container absent the presence of commercial energy sources to include batteries and house electricity. A container that is capable of heating its contents with the use of human generated electricity is the purpose of this invention.

2. Prior Art

Numerous devices have been proposed and used to contain liquids and foods. Such devices range from insulated containers to resealable portable cups.

U.S. Pat. No. 3,105,138 (Gadzik) entitled: “Battery Powered Heater for Conserves” describes a self-contained unit with a heating coil and internal battery pack to keep the food contents warm. The system described in the patent description does not possess a means of generating heat without the presence of batteries. The present invention, however describes a system that is powered by human energy and does not require the use of batteries in order to condition the temperature of the food contents. The configuration described in the patent does not apply to the present invention.

U.S. Pat. No. 0,052,117 A1 (Hernandez) entitled: “Food Warmer and Preserver” describes a food warmer system that uses a combination of pre-heated water and solar panels to preserve the temperature of the contained food content. The configuration described does not apply to the present invention.

U.S. Pat. No. 0,031,547 A1 (Crist) entitled: “Integrated Heater for Food Packaging” describes a food warming system that contains an embedded heating element with exposed contact points to allow for an external power source to be connected to heat the food contents. The configuration described in the patent does not apply to the present invention.

U.S. Pat. No. 0,047,948 A1 (Rosenblum et. al.) entitled: “Portable Food Heater” describes a portable food warming system that uses an induction heating system to generate the heat for the food contents. It requires 110 VAC in order to perform the function of heating the food contents. The configuration described in the patent does not apply to the present invention.

U.S. Pat. No. 3,730,165 (Williams) entitled: “Portable Liquid Heater and Food Warmer” describes a system that requires heating of the food or liquid contents with the use of a gas burner or a canned heat source. The configuration described in the patent does not apply to the present invention.

U.S. Pat. No. 4,095,090 (Pianezza) entitled: “Electrically Heated Container” describes a cup with a rechargeable battery and connectors to facilitate the warming of the cup contents and regeneration of the battery. The configuration described in the patent does not apply to the present invention.

U.S. Pat. No. 6,541,738 B1 (Casasola) entitled: “Portable Food Container with Incorporated Heaters” describes a food container system with embedded heating elements that require external 110 VAC power in order to function. The configuration described in the patent does not apply to the present invention.

To my knowledge, prior to the present invention, there has not been available, or known, a device for carrying beverages or food and for heating both therein and which is small, compact, may be conveniently carried on one's person and generates heat and electricity through the application of human energy.

The present invention produces electricity to excite an internal heating element as well as make available the produced electricity to power external personal electronic devices. Even though the device is compact and portable, it produces heat in an efficient manner to warm beverages and food which makes it very useful for camping and survival scenarios.

### SUMMARY OF THE INVENTION

The present invention provides a device that significantly enhances the manner in which food is temporarily stored and heated. The device allows its owner to heat food by using the power of the person to generate the power to facilitate the heating function. It is a green product. The device is lightweight and easy to carry on one's person.

In addition to temporary food storage products it can actively heat and re-heat food contents in the absence commercial electricity sources. It may be especially useful in camping or survival situations.

Some possible applications for the present invention include traditional short-term food storage, camping and beach food warming, lunch food warming, coffee/tea brewing and hand/body warming in cold weather conditions.

The present invention is an improvement of existing devices that maintain constant temperature environment for food storage applications. Devices of this type keep food contents as close to its original temperature after containment.

While existing devices are widely varied in size, shape and thermal protection of food content, they do not rely on human-powered means of maintaining or adjusting the temperature of the contained contents.

The present invention is proposed specifically to address the challenge of actively conditioning the temperature of contained food using a plurality of human powered methods.

### DETAILED DESCRIPTION

Referring now to the drawings:

In the illustrated preferred embodiment, the invention is described by depicting each of the device components and their positional placement and operational functions, respectively.

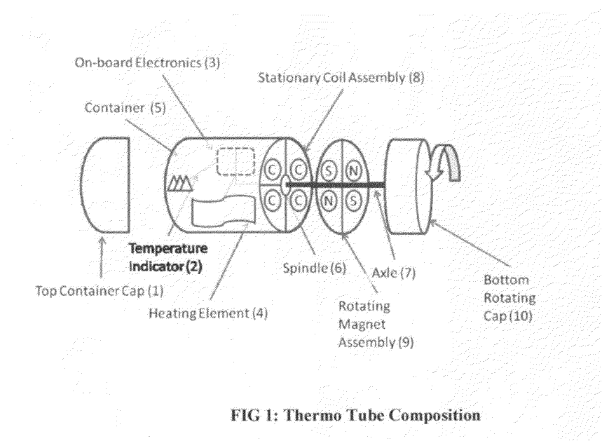

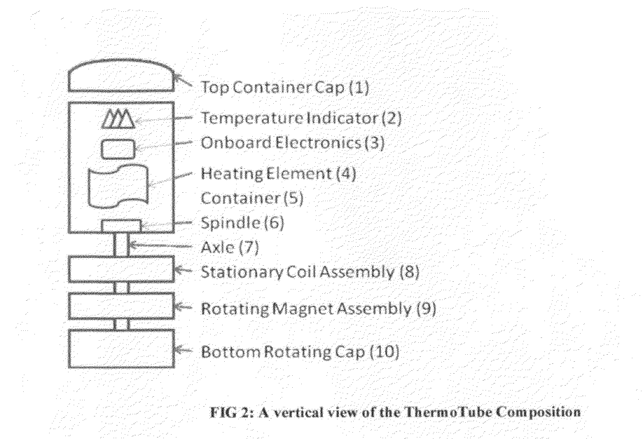

In FIGS. 1 and 2, The Top Containment Cap (1) is a screw-on type cap with a seal that prevents spillage of the food content from the Container (5). The Container (5) is composed of metal to allow for the maximum heat transfer from the Heating Element (4). The Heating Element (4) temperature is regulation by the On-Board Electronics (3) so that the food heating process does not overheat the food in the Container (5).

During the food heating process, the Temperature Indicator (2) transitions through the color range to directly correspond to the temperature of the food or beverage contents within the container. Blue represents cool. Cool is established to be temperatures below the value of 65 degrees Fahrenheit. Orange represents medium. Medium is determined to represent the temperature range of 66 to 89 degrees Fahrenheit. Red represents hot. Hot is established as the range of temperatures between 90 and 110 degrees Fahrenheit. Once the temperature reaches 111 degrees Fahrenheit, the temperature safety mechanism within the On-Board Electronics (3) engages and the generated electricity is automatically decoupled from the Heating Element (4). Each of these colors is calibrated to specific ranges of temperature such that the user knows the relative values of the food temperature.

The invention device displays the temperature range of its contents using color-coded visual indicators composed of one set of three blue, orange and red Light Emitting Diodes (LEDs). The On-Board Electronics (3) has a built-in rechargeable battery to temporarily store energy to power the electronics. Under the Container (5) is a Spindle (6) and Axle (7) assembly that supports the power generation portion of the ThermoTube.

In order to generate power for the ThermoTube, an electrical generator is used. The generator is a composed of a Stationary Coil Assembly (8) and a Rotating Magnet Assembly (9). The Rotating Magnet Assembly is attached directly to the Bottom Rotating Cap (10) and both spin about the Axle (7) to produce the energy for the invention device. Of special note, in FIGS. 1, 2 and 3, the illustrations show distinct spacing between the invention device components that span from the bottom of (6) to the top of (10).

These illustrations are exaggerated to depict component placement and function and bear little relationship to the spacing on the actual invention device. In fact, the spacing of components from the bottom of (6) to the top of (10) may not be discernable on the actual device.

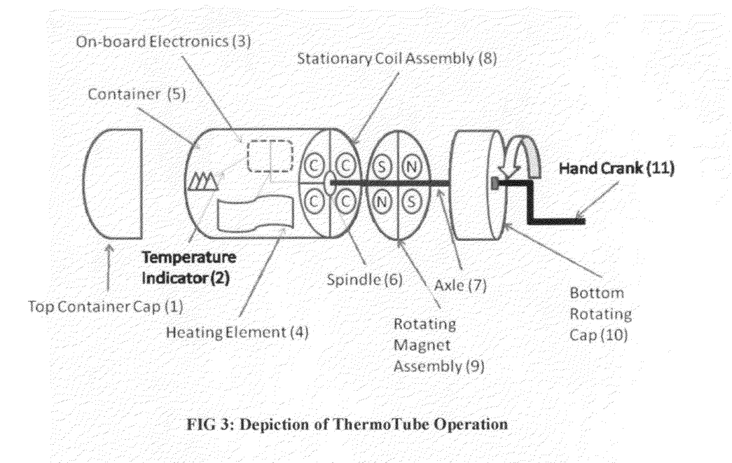

As depicted in FIG. 3. ThermoTube is an original concept that allows the person to store, heat and reheat food in a portable unit that resembles the appearance of traditional food containers. The person may heat the contents of the food by using the invention device in a very straightforward manner.

Once the food is placed in the Container (5), the person spins the Bottom Cap (10) using a plurality of methods. This includes spinning the Bottom Cap (10) directly, or using a Hand Crank (11) device to increase the rate of the spin. As the Bottom Cap (10) is spinning, the Rotating Magnet Assembly (9) spins about the Axle (7) and above the Stationary Coil Assembly (8) to produce electricity for the ThermoTube.

The electricity is transferred to the Heating Element (4) to begin heating the food in the Container (5). The On-Board Electronics (3) regulate the temperature of the heating element and lights up the Temperature Indicator (2) to display the relative temperature to the person. Once the desired temperature is reached, the person ceases spinning the Bottom Rotating Cap (10) and proceeds to consume the food.

In another embodiment of the invention, the Heating Element (4) may be substituted with a temperature conditioning element that is capable of heating or cooling the food content.

Given that the power generator requirements may vary based on the intended use of the invention device, the product may employ a plurality of solutions to meet the energy production requirements. A miniature alternator, for instance, may replace the Stationary Coil Assembly (8) and Rotating Magnet Assembly (9) combination as the primary means of producing electricity.

As another alternative feature, the invention device may be designed with a power output socket that allows for the on-board generator to provide external power to cell phones and portable Global Positioning Systems (GPS) devices. This capability is especially useful for camping situations.

Although the preferred form of my invention has been herein described, it is to be understood that the present disclosure is made by way of example and that variations are possible without departing from the scope of the hereinafter claimed subject matter, which subject matter I regard as my invention.

I claim:

1. A Portable and Human-Powered Food Containment and Temperature Conditioning System comprising:
an insulated container with built-in electronics and manually powered generator to alter the temperature of the beverage or food contents contained therein;
a color coded electronic visual display to indicate the temperature range of the beverage or food contents contained within the device;
an on-board power generator that excites a temperature conditioning element to heat or cool the contents contained within the device;
an on-board electronics assembly that senses the presence of a plug and diverts the generated electricity produced by the on-board generator to the an optional power outlet in order to charge low-power personal electronic devices external to the invention device;
an overheating protection mechanism to automatically disengage the generated electricity from the internal heating element once the established maximum allowed temperature threshold has been reached.
